(19) United States
(12) Patent Application Publication
(10) Pub. No.: US 2024/0399768 A1
(43) Pub. Date: Dec. 5, 2024

(54) DRYING APPARATUS

(71) Applicant: KYOCERA Document Solutions Inc., Osaka (JP)

(72) Inventors: Minoru TOKONAMI, Osaka-shi (JP); Mitsuhiro GODA, Osaka-shi (JP); Masaki MURASHIMA, Osaka-shi (JP); Hiroyuki UEDA, Osaka-shi (JP)

(73) Assignee: KYOCERA Document Solutions Inc., Osaka (JP)

(21) Appl. No.: 18/732,572

(22) Filed: Jun. 3, 2024

(30) Foreign Application Priority Data
Jun. 5, 2023 (JP) 2023-092250

(51) Int. Cl. B41J 11/00; B41J 13/08; B41J 29/377

(52) U.S. Cl. CPC B41J 11/0022; B41J 11/0085; B41J 13/08; B41J 29/377

(57) ABSTRACT

A drying device according to the present disclosure includes a conveying device, an air blowing device, and an exhaust device. The conveying device conveys a medium on which an image is formed, along a predetermined conveyance direction. The air blowing device sends air toward the medium from above the medium conveyed by the conveying device to dry the medium. The exhaust device takes in air above the medium from both sides of the conveying device in a width direction perpendicular to the conveyance direction and exhausts the taken air to an outside.

### INCORPORATION BY REFERENCE

This application is based on and claims the benefit of priority from Japanese patent application No. 2023-092250 filed on Jun. 5, 2023, which is incorporated by reference in its entirety.

### BACKGROUND

The present disclosure relates to a drying apparatus which dries a medium on which an image is formed with ink while conveying the medium.

An image forming system including an inkjet recording apparatus is provided with a drying apparatus which dries the image (ink) formed on the medium. The drying apparatus includes a blowing fan which takes in an outside air and sends it toward the medium.

However, the blowing fan sends the air along a direction substantially perpendicular to the medium. In this case, if a strong wind blows against the medium, the ink may flow and the image quality may deteriorate. When the air blown against the medium flows to the upstream side or the downstream side of the medium in the conveyance direction of the medium, the leading end portion of the succeeding medium is rolled up or the trailing end portion of the preceding medium is rolled up, thereby causing a medium conveyance failure.

### SUMMARY

A drying device according to the present disclosure includes a conveying device, an air blowing device, and an exhaust device. The conveying device conveys a medium on which an image is formed, along a predetermined conveyance direction. The air blowing device sends air toward the medium from above the medium conveyed by the conveying device to dry the medium. The exhaust device takes in air above the medium from both sides of the conveying device in a width direction perpendicular to the conveyance direction and exhausts the taken air to an outside.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing a drying apparatus according to one embodiment of the present disclosure.

FIG. 2 is a perspective view showing the drying apparatus (an air blowing device is not shown) according to the embodiment of the present disclosure.

FIG. 3A is a plan view explaining an air flow, in the drying apparatus according to the embodiment of the present disclosure.

FIG. 3B is a sectional perspective view explaining the air flow, in the drying apparatus according to the embodiment of the present disclosure.

FIG. 4A is a perspective view showing a conveying plate according to a first modified embodiment, in the drying apparatus according to the embodiment of the present disclosure.

FIG. 4B is a perspective view showing the conveying plate according to a second modified embodiment, in the drying apparatus according to the embodiment of the present disclosure.

### DETAILED DESCRIPTION

Hereinafter, with reference to the drawings, a drying apparatus according to one embodiment of the present disclosure will be described.

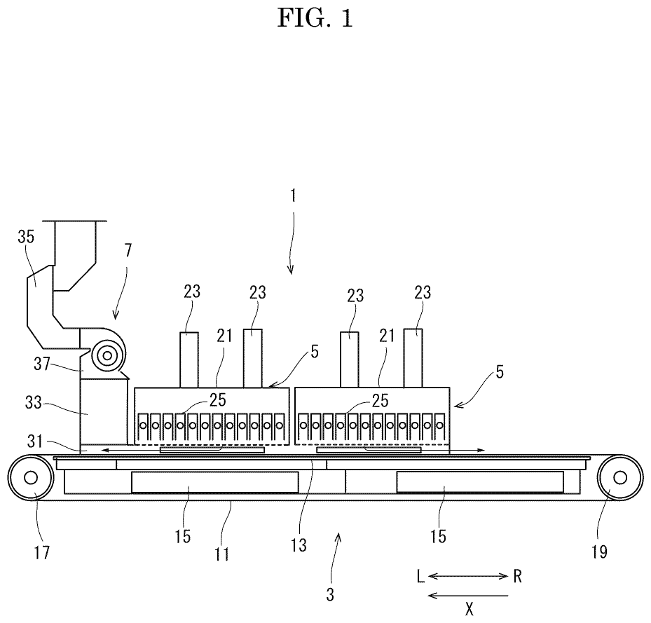

First, with reference to FIG. 1, the entire structure of the drying apparatus 1 will be described. FIG. 1 is a front view showing the inner structure of the drying apparatus 1. In each figure, Fr, Rr, L, and R indicate the front side, rear side, left side, and right side of the drying apparatus 1, respectively.

The drying apparatus 1 includes a conveying device 3 which conveys a medium on which an image is formed by an inkjet method along a conveyance direction X (a direction from the right to the left in FIG. 1), an air blowing device which dries the medium (a cut sheet, a long sheet, and the like) conveyed by the conveying device 3, and an exhaust device 7 which exhausts air in a space above the conveying device 3.

First, the conveying device 3 will be described. The conveying device 3 includes a conveying belt 11 which conveys the medium, a conveying plate 13 which supports the conveying belt 11, and a suction device 15 which attracts the medium to the conveying belt 11.

The conveying belt 11 is an endless belt, and has a number of through-holes penetrating in the thickness direction are formed over the entire surface. The conveying belt 11 is wound around a driving roller 17 and a driven roller 19. When the driving roller 17 is driven by a motor (not shown) to be rotated, the conveying belt 11 travels in the counterclockwise direction of FIG. 1. The outer surface of the conveying belt 11 along the upper track is a conveying surface on which the medium is conveyed.

The conveying plate 13 is in contact with the inner circumferential surface (the surface opposite to the conveying surface) of the conveying belt 11 traveling on the upper track, and supports the conveying belt 11. When the conveying belt 11 travels, the inner circumferential surface of the conveying belt 11 slides along the upper surface of the conveying plate 13. The conveying plate 13 has a number of through-holes penetrating in the thickness direction over the entire surface.

The suction device 15 is arranged in the hollow space of the conveying belt 11. When the suction device 15 is driven, air in the through-holes of the conveying belt 11 and the through-holes of the conveying plate 13 is taken in, and the medium is attracted to the conveying surface of the conveying belt 11.

Next, the air blowing device 5 will be described. In this example, two air blowing devices 5 are arranged above the conveying device 3 side by side in the conveyance direction X. Specifically, two air blowing devices 5 are arranged above the downstream side portion of the conveying device 3 in the conveyance direction X. A predetermined space is formed between the air blowing devices 5 and the conveying surface of the conveying belt 11 of the conveying device 3.

Each air blowing device 5 has a box-like casing 21 with an open lower surface. Two blowing fans 23 are provided on the upper surface of the casing 21. The four fans 23 send air into the casing 21. A heat source 25 is provided inside the casing 21. The heat source 25 heats the air inside the casing 21. The air sent into the casing 21 by the fans 23 is heated by the heat source 25, and the heated air is sent downward, so that the medium conveyed on the conveying surface of the conveying belt 11 of the conveying device 3 is dried.

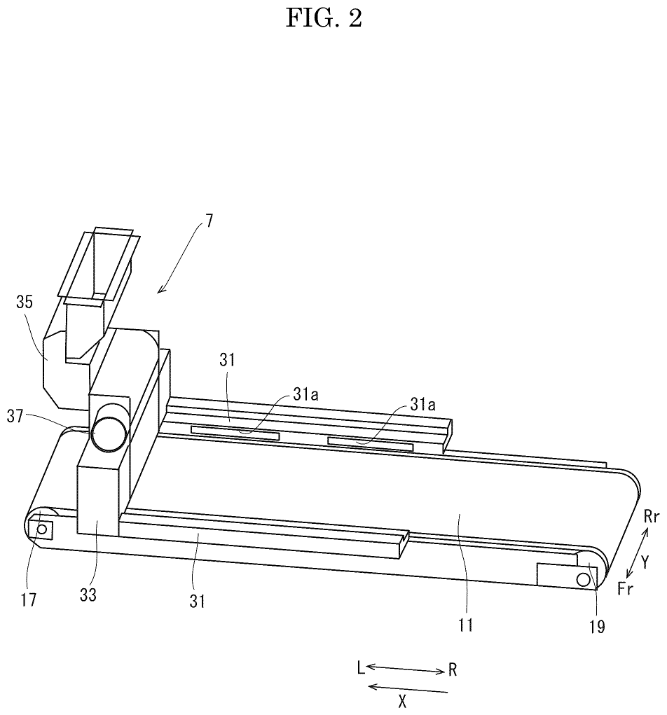

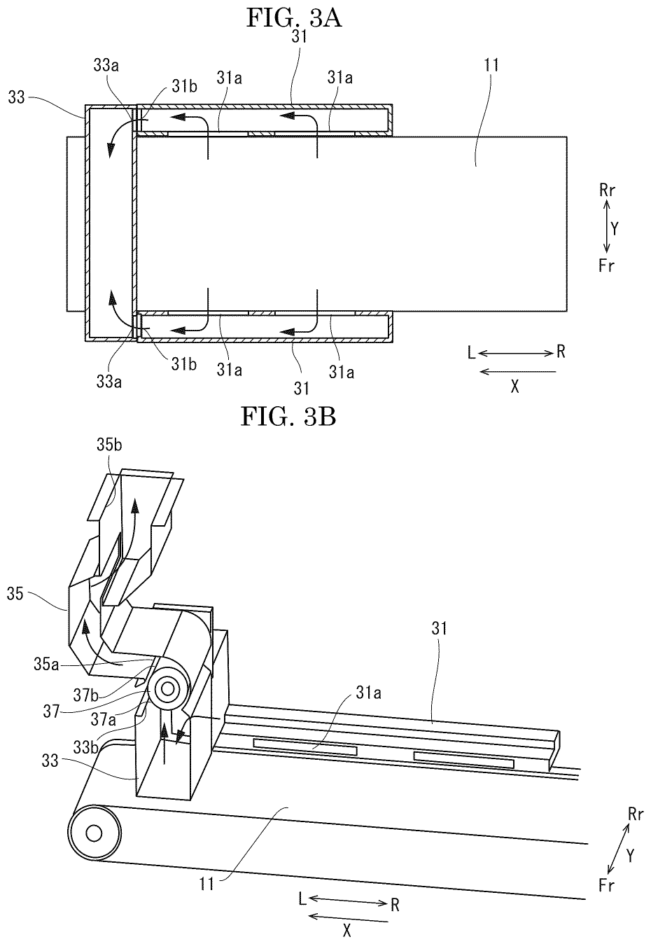

Next, the exhaust device 7 will be described with reference to FIG. 2, and FIG. 3A and FIG. 3B. FIG. 2 is a perspective view showing the drying apparatus 1 (the air blowing device 5 is not shown) viewed from the upper side. FIG. 3A and FIG. 3B are views explaining the air flow of the exhaust device 7.

As shown in FIG. 1 and FIG. 2, the exhaust device 7 is arranged above the conveying device 3 on the downstream side of the air blowing devices 5. The exhaust device 7 includes two intake ducts 31 arranged on both sides of the conveying device 3 in a width direction Y perpendicular to the conveyance direction X, a merging duct 33 with which the intake ducts 31 are merged, an exhaust duct 35 communicating the merging duct 33 with the outside, and a cross-flow fan 37 as an exhaust fan arranged between the merging duct 33 and the exhaust duct 35.

As shown in FIG. 2, the intake ducts 31 are arranged on both sides of the upper track of the conveying belt 11 along the conveyance direction X. The length of the intake duct 31 along the conveyance direction X is substantially equal to the length of the air blowing device 5. On the surface of each intake duct 31 facing a space above the conveyance belt 11, two intake ports 31a along the conveyance direction X are formed. As shown in FIG. 3A, an exhaust port 31b is formed at the downstream end portion of each intake duct 31 in the conveyance direction X. The intake ports 33a of the merging duct 33 communicate with the exhaust ports 31b of the intake ducts 31.

As shown in FIG. 3B, an exhaust port 33b is formed on the upper surface of the merging duct 33. A downward suction port 37a of the cross-flow fan 37 communicates with the exhaust port 33b of the merging duct 33. The blowout port 37b of the cross-flow fan 37 opens on the downstream side in the conveyance direction X, and communicates with the intake port 35a of the exhaust duct 35. The exhaust duct 35 extends upward while being curved. The exhaust port 35b of the exhaust duct 35 is opened upward.

When the cross-flow fan 37 is driven, the air is taken in from the intake ports 31a of the intake ducts 31, and the taken air is exhausted from the intake ducts 31 to the outside through the merging duct 33 and the exhaust duct 35.

The drying operation of the drying apparatus 1 having the above configuration will be described with reference to FIG. 1, FIG. 3A and FIG. 3B. In the conveying device 3, the driving roller 17 is driven to be rotated, the conveying belt 11 travels. Thereafter, the medium on which the image is formed by the inkjet method is conveyed to the conveying surface of the conveying belt 11. Then, the suction device 15 is driven. Thereby, as described above, the air in the through-holes of the conveying belt 11 and the through-holes of the conveying plate 13 is taken in, and the pressure in the space above the conveying surface of the conveying belt 11 becomes negative. Then, the medium is attracted to the conveying surface. As described above, the medium is conveyed along the conveyance direction X while being attracted to the conveying surface of the conveying belt 11.

Further, the air blowing devices 5 are driven, and the air fed into the casing 21 by the fans 23 is heated by the heat source 25, and the heated air is blown downward. The heated air is blown onto the medium conveyed by the conveying belt 11 of the conveying device 3 to dry the medium (ink).

Further, the air is blown downward against the conveying belt 11 and the medium, and flows through the space between the conveying belt 11 and the air blowing devices 5 (the space above the medium) to the upstream side and the downstream side of the conveyance direction X (see the arrows in FIG. 1).

Further, the exhaust fan 37 of the exhaust device 7 is driven. Then, as shown by the arrows in FIG. 3A, the air in the space above the conveying belt 11 is sucked through the intake ports 31a of the intake ducts 31. The sucked air flows to the downstream side in the intake ducts 31 toward the merging duct 33. The sucked air then rises through the merging duct 33, and exhausts out through the exhaust duct 35, as shown by the arrow in FIG. 3B.

As is apparent from the above description, according to the drying apparatus 1 of the present disclosure, the air in the space above the conveying belt 11 is sucked into the intake ducts 31 along the width direction Y. Therefore, it becomes possible to reduce an amount of the air sent from the air blowing device 5 to the space above the conveying belt 11 and flowing to the upstream side or the downstream side of the conveyance direction X (indicated by the arrows in FIG. 1). Therefore, the conveyance failure of the medium in which the leading end portion of the succeeding medium is rolled up and the trailing end portion of the preceding medium is rolled up can be suppressed.

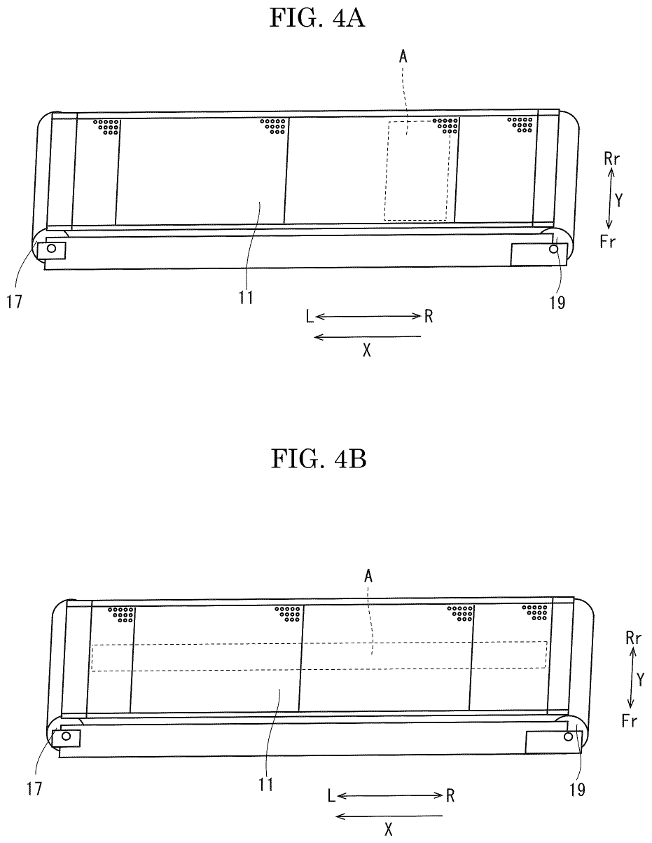

Next, modified examples of the drying apparatus 1 of the present disclosure will be described with reference to FIG. 4A and FIG. 4B. FIG. 4A and FIG. 4B are perspective views schematically showing the conveying plate 13 of the conveying device 3.

In the first modified shown in FIG. 4A, the portion A of the conveying plate 13 on the upstream side of the air blowing device 5 in the conveyance direction X is formed such that the force for attracting the medium is large. Specifically, by adjusting the diameter and the number of through-holes formed in the conveying plate 13, the force for attracting the medium can be made larger than that of the other portion.

As described above, the air sent from the air blowing device 5 to the space above the conveying belt 11 and then flowing to the upstream side of the conveyance direction X may cause the leading end portion of the succeeding medium to roll up. Therefore, by increasing the force to attract the medium to the conveying belt 11 on the downstream side of the air blowing device 5, the rolling up of the medium can be more surely suppressed. A part of the conveying plate 13 on the downstream side of the air blowing device 5 in the conveyance direction X may also be formed so as to increase the force for attracting the medium.

In the second modified example shown in FIG. 4B, the central portion A of the conveying plate 13 in the width direction Y is formed so as to increase the force for attracting the medium. More specifically, as described above, by adjusting the diameter and the number of through-holes, the force to attract the medium can be increased more than that of the other portion.

When the size of the medium is small, the leading end portion of the medium is particularly rolled up by the air sent from the air blowing device 5 to the space above the conveying belt 11 and flowing to the upstream side of the conveyance direction X. Therefore, the force for attracting the medium to the conveying belt 11 is increased in the central portion A in the width direction Y, so that the small size medium can be surely attracted to the conveying belt 11 and conveyed. Further, even in the medium other than a small size, the rolling up of the medium can be suppressed by increasing the force for attracting the central portion A to the conveying belt 11.

Although the present disclosure has been described in particular embodiments, the present disclosure is not limited to the foregoing embodiments. To the extent that it does not deviate from the scope and object of the present disclosure, the foregoing embodiments may be variously changed, substituted, or modified, and the claims include all embodiments that may fall within the scope of technical thought.

1. A drying apparatus comprising:
a conveying device which conveys a medium on which an image is formed, along a predetermined conveyance direction;
an air blowing device which sends air toward the medium from above the medium conveyed by the conveying device to dry the medium; and
an exhaust device which takes in air above the medium from both sides of the conveying device in a width direction perpendicular to the conveyance direction and exhausts the taken air to an outside.

2. The drying apparatus according to claim 1, wherein
the exhaust device includes ducts disposed on both sides of the conveying device in the width direction, and takes in the air above the medium through the ducts.

3. The drying apparatus according to claim 2, wherein
the exhaust device includes a merging duct with which the ducts are merged, an exhaust duct which communicates the merging duct with an outside air, and a fan disposed between the merging duct and the exhaust duct.

4. The drying apparatus according to claim 1, wherein
the air blowing device is disposed above a downstream portion of the conveying device in the conveyance direction.

5. The drying apparatus according to claim 1, wherein
the exhaust device is disposed on a downstream side of the air blowing device in the conveyance direction.

6. The drying apparatus according to claim 1, wherein
the conveying device includes:
an endless conveying belt having a conveying surface supporting the medium and having a number of through-holes;
a conveying plate supporting the conveying belt in contact with a surface opposite to the conveying surface of the conveying belt and having a number of through-holes; and
a suction device which applying negative pressure to the through-holes of the conveying belt and the through-holes of the conveying plate to attract the medium to the conveying surface, wherein
the conveying plate is formed such that a force to attract the medium to the conveying surface is larger on the upstream side of the air blowing device than on the downstream side of the air blowing device in the conveyance direction.

7. The drying apparatus according to claim 1, wherein
the conveying device includes:
an endless conveying belt having a conveying surface supporting the medium and having a number of through-holes;
a conveying plate supporting the conveying belt in contact with a surface opposite to the conveying surface of the conveying belt and having a number of through-holes; and
a suction device which applying negative pressure to the through-holes of the conveying belt and the through-holes of the conveying plate to attract the medium to the conveying surface, wherein
the conveying plate is formed such that a force to attract the medium to the conveying surface is larger on a center side than on both end sides in the width direction.
